(19) United States
(12) Patent Application Publication
(10) Pub. No.: US 2008/0284395 A1
(43) Pub. Date: Nov. 20, 2008

(54) Low Dropout Voltage regulator

(75) Inventors: Zhao WANG, Beijing (CN); Hang YIN, Beijing (CN); WenBo TIAN, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/043,990

(22) Filed: Mar. 7, 2008

(30) Foreign Application Priority Data
Mar. 21, 2007 (CN) 200710064617.X

(51) Int. Cl. G05F 1/08

(52) U.S. Cl. 323/282

(57) ABSTRACT

Techniques pertaining designs of LDO voltage regulators are described. According to one design, the LDO voltage regulator comprises: a differential amplifier circuit having a pair of input terminals and an output terminal, one of the input terminals coupled to a predetermined reference voltage; an intermediate amplifier circuit having an output terminal and an input terminal coupled to the output terminal of the differential amplifier circuit; and an output pass circuit comprising a pass transistor, an output resistor and an output capacitor, the pass transistor having a control terminal coupled to the output terminal of the intermediate amplifier circuit, an input terminal coupled to a power supply and an output terminal coupled to one terminal of the output resistor, the other terminal of the output resistor taken as a voltage output node, the output capacitor coupled between the voltage output node and a ground reference; a feedback circuit including a pair of ladder resistors coupled in series between the voltage output node and the ground reference, a node between the ladder resistors coupled to the other one of the input terminals of the differential amplifier circuit; and a voltage controlled current source circuit having an input terminal coupled to a node between the pass transistor and the output resistor of the output pass circuit and an output terminal coupled to the node between the ladder resistors.

### BACKGROUND OF THE INVENTION

1. Field of the Invention

The present invention relates to a voltage regulator, more particularly to a low dropout voltage regulator.

2. Description of Related Art

DC/DC power (or voltage) converters are important in many electronic devices such as cellular phones and laptop computers, which are often supplied with power from batteries. Such electronic devices often contain several circuits with each circuit requiring a unique voltage level different from one supplied by the battery (sometimes being higher or lower than the battery voltage, and possibly even having negative voltage). Additionally, the battery voltage declines as its stored power is drained. DC to DC converters offer a method of generating multiple controlled voltages from a single variable battery voltage, thereby saving space instead of using multiple batteries to supply different parts of the device. Examples of input voltage Vcc/output voltage Vout including 5V/3.3V, 5V/1.8V or 5V/1.2V etc. are widely used in various power management systems. Usually, an inductor and an output capacitor, which are very expensive and bulky, are necessary for a DC/DC down-converter.

Unlike many Switching Mode Power Supply (SMPS), a low dropout (LDO) voltage regulator needs only one capacitor for operation. In a prior art solution, it has been reduced to 1 uF or less. As a voltage supply, the LDO voltage regulator demonstrates many advantages in applications. Perfect line and load regulation, high power supply rejection ratio (PSRR), fast response, very small quiescent current, and low noise make an LDO regulator irreplaceable. However, stabilizing the LDO voltage regulator with 1 uF low ESR (equivalent series resistance) ceramic capacitor under a large output current is still a challenge.

FIG. 1 shows a typically conventional LDO voltage regulator 100. The specific description of the conventional LDO voltage regulator may be referred to in a reference entitled “A Frequency Compensation Scheme for LDO Voltage Regulators”, invented by Chaitanya K. Chava and Jose Silva-Martinez, IEEE J. Solid-State Circuits, vol. 51, pp. 1041-1050, June 2004, which is hereby incorporated by reference.

The LDO voltage regulator 100 comprises a differential amplifier circuit 102, an intermediate amplifier circuit 104, an output pass circuit 106, a feedback circuit 108 and a voltage controlled current source circuit 110. These circuits are interconnected to form a voltage negative feedback loop.

The differential amplifier circuit 102 includes a differential amplifier gm1, a resistor R₁ and a capacitor C₁ connected in parallel between an output terminal of the differential amplifier gm1 and a ground reference. The resistor R₁ and the capacitor C₁ may be an equivalent series resistance (ESR) and an equivalent series capacitance (ESC) of the differential amplifier circuit, respectively.

The intermediate amplifier circuit 104 includes an amplifier gm2, a resistor R₂ and a capacitor C₂ connected in parallel between an output terminal of the amplifier gm2 and the ground reference. An input terminal of the amplifier gm2 is connected to the output terminal of the differential amplifier gm1. The resistor R₂ and the capacitor C₂ may be the ESR and the ESC of the intermediate amplifier circuit, respectively.

The output pass circuit gm3 106 includes a pass transistor MPass and an output capacitor Co. The pass transistor MPass usually is a P-type MOS field effect transistor. A control terminal of the pass transistor MPass such as a gate electrode of the MOS transistor is connected to the output terminal of the amplifier gm2. An input terminal of the pass transistor MPass such as a source electrode of the MOS transistor is connected to a power supply Vcc. An output voltage Vout is leaded from an output terminal of the pass transistor MPass such as a drain electrode of the MOS transistor. The output capacitor Co and a resistor R_{L} representative of a load are connected in parallel between the output voltage Vout and the ground reference.

The feedback circuit 108 includes a pair of ladder resistors R_{f1} and R_{f2} connected in series between the output voltage Vout and the ground reference. One terminal of the resistor R_{f1} is connected to the output terminal of the pass transistor MPass. A middle node B between the resistor R_{f1} and the resistor R_{f2} is connected to an input terminal of the differential amplifier gm1 for feedback. Another input terminal of the differential amplifier is connected to a predetermined reference voltage.

An input terminal of the voltage controlled current source circuit 110 is connected to a node A between the pass transistor and the feedback circuit, and an output terminal of the voltage controlled current source circuit is connected to the node B. The voltage controlled current source circuit is designed for inputting a constant current into the node B depending on a voltage between the node A and the node B. The voltage controlled current source circuit includes a compensation capacitor C_{c}, a current mirror and a differential pair circuit.

In FIG. 1, the output capacitor Co and the ESR (not shown) of the output capacitor Co forms a zero. The zero frequency is shown in an equation as follows.

$${f}_{ESR} = \frac{1}{2 π {R}_{ESR} {C}_{o}}$$

For a small ceramic output capacitor Co with low ESR, the zero f_{ESR} is usually neglected because it is at very high frequency.

In FIG. 1, it can be determined that there are three poles and one zero:

$${f}_{P 1} = \frac{1}{2 π {R}_{1} {C}_{1}} , {f}_{P 2} = \frac{1}{2 π {R}_{2} {C}_{2}} , {f}_{P 3} = \frac{1}{2 π {R}_{L} {C}_{O}} , {f}_{Z 1} = \frac{1}{2 π {R}_{f 1} {C}_{C}}$$

The pole fₚ₁ is formed by the output resistor R₁ and the output capacitor C₁ of the differential amplifier circuit. The pole fₚ₂ is formed by the output resistor R₂ and the output capacitor C₂ of the intermediate amplifier circuit. The pole fₚ₃ formed by the load resistor RL and the output capacitor C₂ of the output pass circuit. To stabilize the voltage negative feedback loop, one zero must be designed to cancel one pole, another pole must be pushed beyond the cross-over frequency and only one pole may be designed to be a domain pole. In the reference mentioned above, the pole f_{P3} is designed to be the dominant pole, the zero f_{Z1} is designed to cancel the pole fₚ₂, and the pole f_{P1} is pushed to high frequency beyond bandwidth. It should be noted that the pole fₚ₂ may be cancelled by the zero f_{Z1} as long as the zero f_{Z1} is adjacent to the pole fₚ₂, but not requiring the zero f_{Z1} to be equal to the pole fₚ₂.

However, in order to push the pole f_{P1} to a higher frequency, the differential amplifier circuit must be designed to be small in size so as to minimize capacitance and resistance at the signal path thereof. However, such a design may lead to a mismatch. At the same time, the bandwidth is limited and the PSRR over 10 KHz may be poor.

Thus, improved techniques for a LDO voltage regulator are desired to overcome some or all of the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to designs of LDO voltage regulators. According to one design, the LDO voltage regulator comprises: a differential amplifier circuit having a pair of input terminals and an output terminal, one of the input terminals coupled to a predetermined reference voltage; an intermediate amplifier circuit having an output terminal and an input terminal coupled to the output terminal of the differential amplifier circuit; and an output pass circuit comprising a pass transistor, an output resistor and an output capacitor, the pass transistor having a control terminal coupled to the output terminal of the intermediate amplifier circuit, an input terminal coupled to a power supply and an output terminal coupled to one terminal of the output resistor, the other terminal of the output resistor taken as a voltage output node, the output capacitor coupled between the voltage output node and a ground reference; a feedback circuit including a pair of ladder resistors coupled in series between the voltage output node and the ground reference, a node between the ladder resistors coupled to the other one of the input terminals of the differential amplifier circuit; and a voltage controlled current source circuit having an input terminal coupled to a node between the pass transistor and the output resistor of the output pass circuit and an output terminal coupled to the node between the ladder resistors.

There are many objects, features, and advantages in the present invention. These objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG.1 shows a typically conventional LDO voltage regulator;

FIG. 2 shows a LDO voltage regulator according to one embodiment of the present invention;

FIG. 3 is a diagram showing a small signal equivalence of the circuit from Vg to Vf shown in FIG. 2;

FIG. 4 shows a LDO voltage regulator according to another embodiment of the present invention; and

FIG. 5 shows a LDO voltage regulator according to still another of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

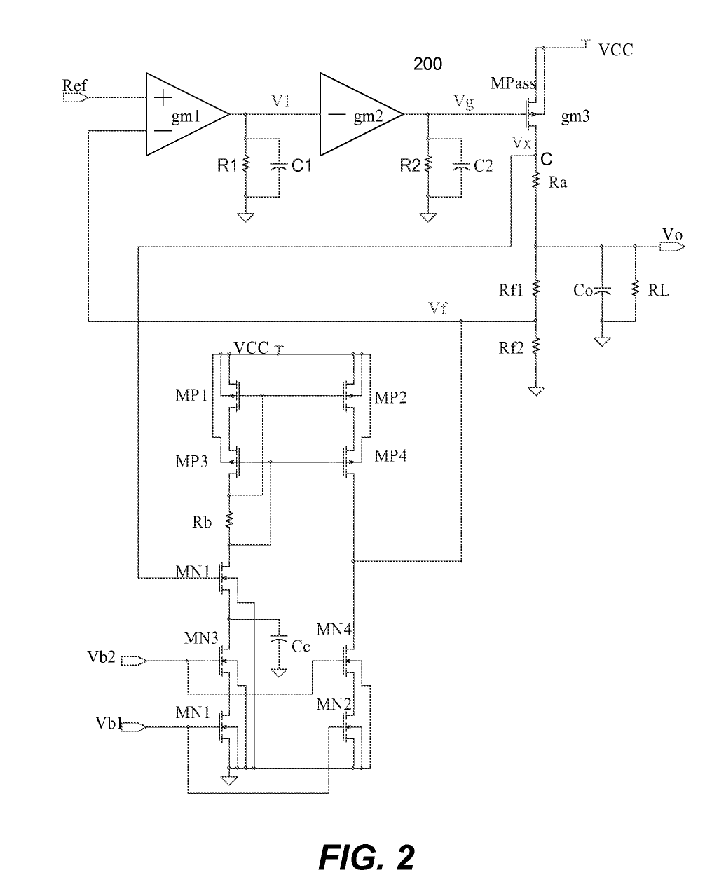

Embodiments of the present invention are discussed herein with reference to FIGS. 2-5. However, those skilled in the art will readily appreciate that the detailed description given herein with respect to these figures is for explanatory purposes only as the invention extends beyond these limited embodiments.

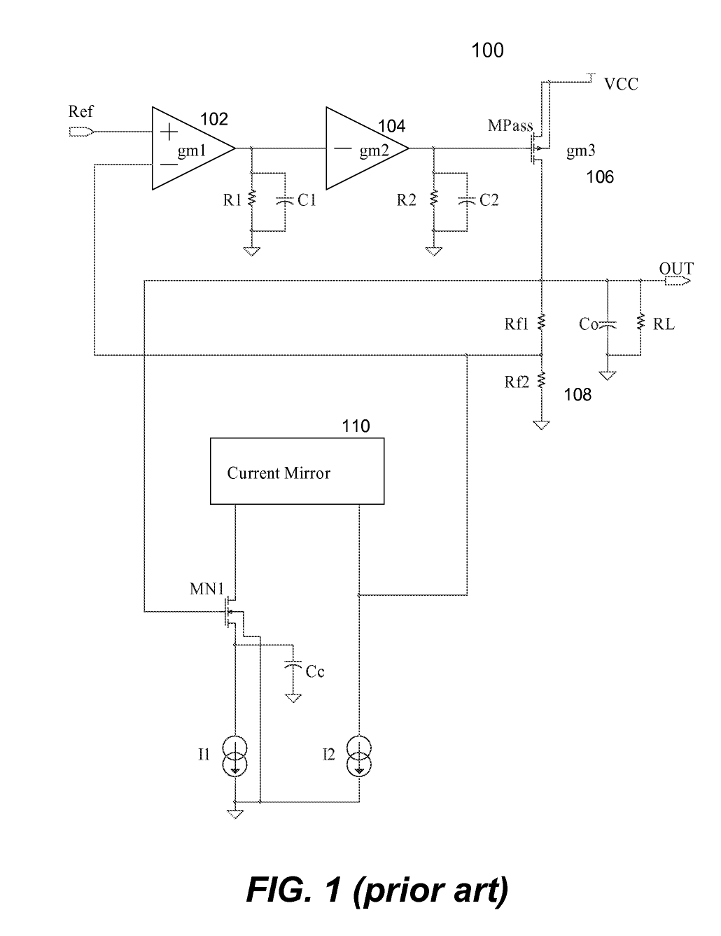

Several embodiments are provided to fully describe a low dropout (LDO) voltage regulator in the present invention. FIG. 2 shows a LDO voltage regulator 200 according to an embodiment of the present invention. The LDO voltage regulator 200 shown in FIG. 2 has at least two differences from the conventional LDO voltage regulator shown in FIG. 1. The first one is that a resistor Ra is added between an output terminal of a pass transistor MPass and a voltage output node A based on FIG. 1. The second one is that an input terminal of a voltage controlled current source circuit is coupled to a node C between the pass transistor MPass and the resistor Rₐ. With the new structure, another zero is added.

It is assumed that a voltage of the node C is Vx, and a voltage of a node B between a resistors R_{f1} and a resistor R_{f2} of a feedback circuit is Vf. It should be noted that the voltage controlled current source circuit between the Vx and the Vf is identical with the corresponding voltage controlled current source circuit shown in FIG. 1 except for a specific structure.

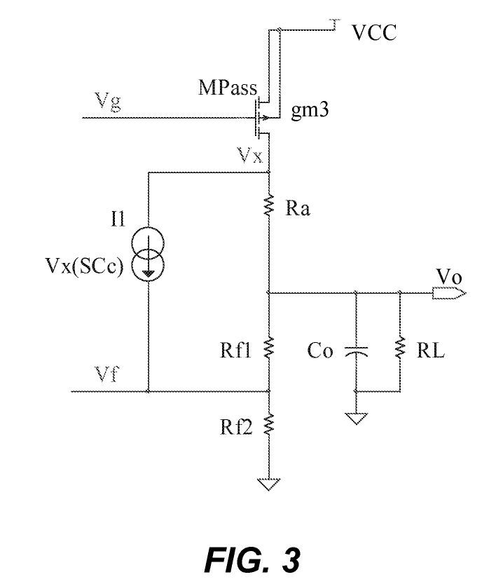

FIG. 3 is a diagram showing a small signal equivalence of the circuit from Vg to Vf in the LDO voltage regulator shown in FIG. 2, where the voltage controlled current source circuit is replaced by a current source. According to KCL (Kirchhoff's Current Law) at the nodes A, B and C, the following three equations exist.

$$\begin{matrix}{g}_{m 3} {V}_{g} = {V}_{x} ( {SC}_{C} ) + ( {V}_{x} - {V}_{O} ) / {R}_{a} & ( 1 ) \\ ( {V}_{x} - {V}_{O} ) / {R}_{a} = ( {V}_{O} - {V}_{f} ) / {R}_{f 1} + {V}_{O} / ( {R}_{L} // \frac{1}{{SC}_{O}} ) & ( 2 ) \\ {V}_{x} ( {SC}_{C} ) + ( {V}_{O} - {V}_{f} ) / {R}_{f 1} = {V}_{f} / {R}_{f 2} & ( 3 )\end{matrix}$$

Solving these equations with the assumption Rₐ<<R_{L}<<R_{f1} and Rₐ<<R_{L}<<R_{f2}, it can be obtained:

$${V}_{f} / {V}_{g} = \frac{{g}_{m 3} [ {R}_{a} {R}_{f 1} {S}^{2} {C}_{C} {C}_{O} + {SC}_{C} {R}_{f 1} + 1 ]}{( 1 + \frac{{R}_{f 1}}{{R}_{f 2}} ) [ {C}_{C} {C}_{O} {R}_{a} {S}^{2} + {SC}_{O} + \frac{1}{{R}_{L}} ]} \qquad ( 4 )$$

The equation (4) is a transfer function for the circuit of FIG. 3. The transfer function includes two poles and two zeros. The Rₐ<<R_{L} means that a resistance value of the resistor R_{L} is an order of magnitude higher than that of the resistor Rₐ (e.g. Rₐ<R_{L}/10). Provided that Rₐ=0, the equation (4) becomes:

$${V}_{f} / {V}_{g} = \frac{{g}_{m 3} ⌊ {SC}_{C} {R}_{f 1} + 1 ⌋}{( 1 + \frac{{R}_{f 1}}{{R}_{f 2}} ) [ {SC}_{O} + \frac{1}{{R}_{L}} ]} \qquad ( 5 )$$

Then, one pole and one zero are obtained according to the equation (5):

$${f}_{P a 1} = \frac{1}{2 π {R}_{L} {C}_{O}} , {f}_{Za 1} = \frac{1}{2 π {R}_{f 1} {C}_{C}}$$

Finally, another pole and another zero are obtained after the calculation:

$${f}_{P a 2} = \frac{1}{2 π {R}_{a} {C}_{C}} , {f}_{Za 2} = \frac{1}{2 π {R}_{a} {C}_{O}}$$

In one embodiment, C_{C} usually is far lower than any one of Co, C₁ and C₂. Since the resistor Rₐ and the capacitor C_{C} both are very small, e.g. Rₐ is about 0.1 ohm and C_{C} is 1 pF, the pole f_{Pa2} is pushed to a very high frequency and can be neglected.

Taking a pole fₚ₁ formed by an output resistor R₁ and an output capacitor C₁ of the differential amplifier circuit and a pole fₚ₂ formed by an output resistor R₂ and an output capacitor C₂ of the intermediate amplifier circuit into account, the LDO regulator shown in FIG. 2 has three poles and two zeros in total:

$${f}_{P 1} = \frac{1}{2 π {R}_{1} {C}_{1}} , {f}_{P 2} = \frac{2}{2 π {R}_{2} {C}_{2}} , {f}_{P 3} = \frac{1}{2 π {R}_{L} {C}_{O}} , {f}_{Z 1} = \frac{1}{2 π {R}_{f 1} {C}_{C}} , {f}_{Z 2} = \frac{1}{2 π {R}_{a} {C}_{O}}$$

Comparing to the LDO voltage regulator shown in FIG. 1, another zero f_{z2} formed by the resistor Rₐ and the output capacitor Co is added within the bandwidth of the LDO regulator shown in FIG. 2.

To drive a 300 mA or bigger current, the pass transistor MPass is designed large in size so that large capacitance at the node of the gate electrode thereof is generated. The large capacitance of the pass transistor MPass is a part of the capacitor C₂. Thus, the pole f_{P2} is taken as a dominant pole. The pole f_{P1} and the pole f_{P3} are canceled by the zero f_{Z1} and the zero f_{Z2} respectively. As a result, the voltage negative feedback loop is very stable and has a phase margin of about 90 degree.

For example, the pole fₚ₁ is designed to be adjacent to the zero f_{z2} by choosing values of R₁, C₁, Rₐ and Cₒ so that the pole f_{P1} can be canceled by the zero f_{Z2}. In a preferred embodiment, a value of fₚ₁/f_{z2} may be within 1/3˜3. Correspondingly, the pole fₚ₃ is designed to be adjacent to the zero f_{z1} by choosing values of R₂, C₂, R_{f1} and C_{c} so that the pole fₚ₃ can be canceled by the zero f_{z1}. In a preferred embodiment, a value of fₚ₃/f_{z1} may be within 1/3˜3. An exemplary design is that R_{L}=11Ω, C_{O}=0.5 uF, fₚ₃≈29 KHz; R_{f1}=1450 KΩ, Cc=3.8 pF, f_{z1}≈29 KHz; Rₐ=0.44106, C_{O}=0.5 uF, f_{z2}≈716 KHz; R1=112 KΩ, C1=2 pF, and fₚ₁≈711 KHz.

It should be noted that there are various selections for values of the above parameters. Different parameter selections may result in different domain poles. Furthermore, there is no fixed mode in cancellation of the poles via the zero. Due to the addition of the resistor Rₐ, another zero within the bandwidth is provided in the LDO voltage regulator shown in FIG. 2 to cancel a redundant pole so that the stability of the feedback loop is increased. To avoid the adverse influence of the resistor Rₐ, the value of the resistor Rₐ is designed to be far less than that of the resistor R_{L}, for example Rₐ<R_{L}/10. Usually, the value of the resistor Rₐ is designed to less than 1Ω.

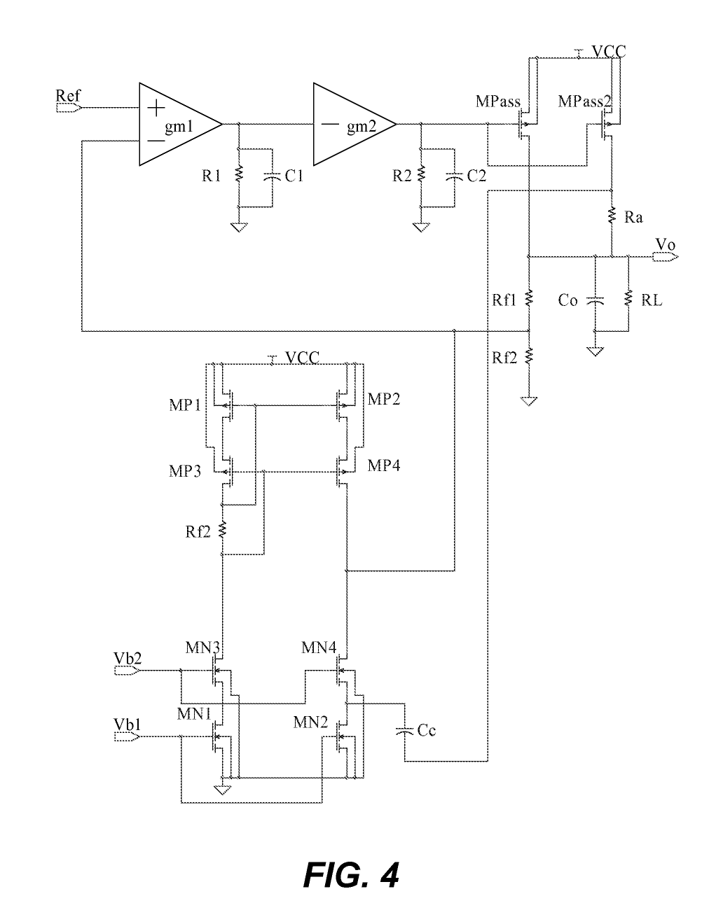

In the embodiment of FIG. 2, since the resistor Rₐ requires to satisfy a predetermined condition and avoid an obvious voltage dropout thereon, the resistor Rₐ must be designed to be very small. The value of the resistor Rₐ is preferably designed to be less than 1Ω. It is difficult to fabricate such a resistor with so small resistance. Hence, FIG. 4 shows another LDO voltage regulator according to one embodiment of the present invention. In FIG. 4, the output pass circuit includes a pair of P-type pass transistors connected in parallel between the voltage output node A and the power supply Vcc. One is referred to as a first pass transistor MPass1, the other is referred to as a second pass transistor MPass. The resistor Rₐ is connected between the second pass transistor MPass and the voltage output node A. The input terminal of the voltage controlled current source circuit is connected to the node C between the second pass transistor MPass and the resistor Rₐ.

The ratio P of width to length of the second pass transistor MPass is far less than that the ration O of the first pass transistor MPass1. The ratio N of P to O is within 1/1000˜1/100 in a preferred embodiment. The ratio N is around 1/900 in this embodiment. Thereby, the current flowing through the second pass transistor MPass is far less than that flowing through the first pass transistor MPass1. In fabrication, one transistor from thousands of P-type MOS transistors connected in parallel is taken as the second pass transistor MPass, the other transistors are taken as the first pass transistor MPass1.

According to a small signal equivalence of the circuit from the Vg to the Vf in the LDO regulator shown in FIG. 4, the transfer function can be got by a same way mentioned above. Subsequently, a zero can be got according to similar method in the first embodiment.

$${f}_{Z 2} = \frac{1}{2 π {R}_{a} {C}_{O} / N}$$

The value of the Rₐ/N in the second embodiment may be near to the value of the Rₐ in the first embodiment, thereby the resistor Rₐ may has an order of magnitude of 100 Ω.

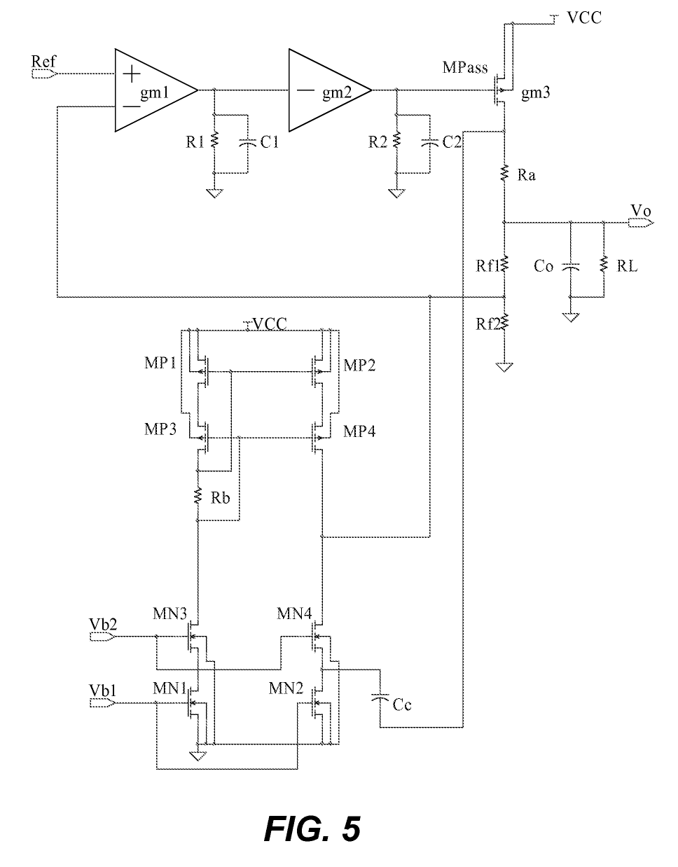

FIG. 5 shows a LDO voltage regulator according to another embodiment of the present invention. Comparing with FIG. 2, the voltage controlled current source circuit in the embodiment has an alternative structure.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A LDO voltage regulator comprising:
a differential amplifier circuit having a pair of input terminals and an output terminal, one of the input terminals coupled to a predetermined reference voltage;
an intermediate amplifier circuit having an output terminal and an input terminal coupled to the output terminal of the differential amplifier circuit; and
an output pass circuit comprising a pass transistor, an output resistor and an output capacitor, the pass transistor having a control terminal coupled to the output terminal of the intermediate amplifier circuit, an input terminal coupled to a power supply and an output terminal coupled to one terminal of the output resistor, the other terminal of the output resistor taken as a voltage output node, the output capacitor coupled between the voltage output node and a ground reference;
a feedback circuit including a pair of ladder resistors coupled in series between the voltage output node and the ground reference, a node between the ladder resistors coupled to the other one of the input terminals of the differential amplifier circuit; and
a voltage controlled current source circuit having an input terminal coupled to a node between the pass transistor and the output resistor of the output pass circuit and an output terminal coupled to the node between the ladder resistors.

2. The LDO voltage regulator according to claim 1, wherein the pass transistor is a P-type MOS field effect transistor, a gate electrode of the MOS field effect transistor serves as the control terminal, a source electrode of the MOS field effect transistor serves as the input terminal and a drain electrode of the MOS field effect transistor serves as the output terminal.

3. The LDO voltage regulator according to claim 1, further comprising a load resistor coupled between the voltage output node and the ground reference.

4. The LDO voltage regulator according to claim 3, wherein a resistance value of the output resistor is an order of magnitude less than that of the load resistor which is an order of magnitude less than that of either of the ladder resistors.

5. The LDO voltage regulator according to claim 4, wherein a capacitance value of a compensation capacitor of the voltage controlled current source circuit is an order of magnitude less than minimum capacitance value among an output capacitor of the differential amplifier circuit, an output capacitor of the intermediate amplifier circuit and the output capacitor of the output pass circuit.

6. The LDO voltage regulator according to claim 5, wherein the LDO voltage regulator has three poles and two zeros within bandwidth, two of the three poles are cancelled by corresponding zeros and another pole is designed to be a domain pole, and wherein one of the two zeros is formed by the output capacitor and the output resistor of the output pass circuit.

7. A LDO voltage regulator comprising:
a differential amplifier circuit having a pair of input terminals and an output terminal, one input terminal coupled to a predetermined reference voltage;
an intermediate amplifier circuit having an input terminal and an output terminal, the input terminal coupled to the output terminal of the differential amplifier circuit;
an output pass circuit comprising a first pass transistor, a second pass transistor coupled with the first pass transistor in series, an output resistor and an output capacitor, each pass transistor having a control terminal coupled to the output terminal of the intermediate amplifier circuit, an input terminal coupled to a power supply and an output terminal, the output terminal of the second pass transistor coupled to one terminal of the output resistor, the other terminal of the output resistor taken as a voltage output node, the output terminal of the first pass transistor coupled to the voltage output node, the output capacitor coupled between the voltage output node and a ground reference;
a feedback circuit comprising a pair of ladder resistors coupled in series between the voltage output node and the ground reference, a node between the ladder resistors coupled to the other input terminal of the differential amplifier circuit;
a voltage controlled current source circuit having an input terminal coupled to a node between the second pass transistor and the output resistor of the output pass circuit and an output terminal coupled to the node between the ladder resistors.

8. The LDO voltage regulator according to claim 7, wherein the pass transistors both are P-type MOS field effect transistors, a gate electrode of the MOS field effect transistor serves as the control terminal, a source electrode of the MOS field effect transistor serves as the input terminal, and a drain electrode of the MOS field effect transistor serves as the output terminal.

9. The LDO voltage regulator according to claim 7, wherein the ratio of width to length of the first pass transistor is O, the ratio of width to length of the second pass transistor is P, the ratio N of O to P is within 100˜1000.

10. The LDO voltage regulator according to claim 9, further comprising a load resistor coupled between the voltage output terminal and the ground reference.

11. The LDO voltage regulator according to claim 10, wherein a value of Rₐ/N is an order of magnitude less than that of the load resistor which is an order of magnitude lower than that of either of the ladder resistors, wherein Rₐ represents the output resistor of the output pass circuit.

12. The LDO voltage regulator according to claim 11, wherein a capacitance value of a compensation capacitor of the voltage controlled current source circuit is an order of magnitude lower than minimum capacitance value among an output capacitor of the differential amplifier circuit, an output capacitor of the intermediate amplifier circuit and the output capacitor of the output pass circuit.

13. A LDO voltage regulator comprising:
an output pass circuit comprising a pass transistor, an output resistor and an output capacitor, the pass transistor having an input terminal coupled to a power supply and an output terminal coupled to one terminal of the output resistor, the other terminal of the output resistor taken as a voltage output node, the output capacitor coupled between the voltage output node and a ground reference;
wherein one zero is formed by the output resistor and the output capacitor.

14. The LDO voltage regulator according to claim 13, further comprising:
an amplifier circuit having a pair of input terminals and an output terminal coupled to a control terminal of the pass transistor, one input terminal coupled to a predetermined reference voltage;
a feedback circuit comprising a pair of ladder resistors coupled in series between the voltage output node and the ground reference, a node between the ladder resistors coupled to the other input terminal of the differential amplifier circuit;
a voltage controlled current source circuit having an input terminal coupled to a node between the pass transistor and the output resistor of the output pass circuit and an output terminal coupled to the node between the ladder resistors.
